(19) United States
(12) Patent Application Publication
(10) Pub. No.: US 2025/0203603 A1
(43) Pub. Date: Jun. 19, 2025

(54) DYNAMIC SCHEDULING OF PERIODIC COMMUNICATION IN A WIRELESS NETWORK

(71) Applicant: Sony Group Corporation, Tokyo (JP)

(72) Inventors: Basuki PRIYANTO, Lund (SE); Shin Horng WONG, Basingstoke (GB); Anders BERGGREN, Lund (SE)

(21) Appl. No.: 18/849,864

(22) PCT Filed: Mar. 22, 2023
(86) PCT No.: PCT/EP2023/057390

§ 371 Date: Sep. 23, 2024

(30) Foreign Application Priority Data
Apr. 14, 2022 (SE) 2250462-5

(51) Int. Cl. H04W 72/1263; H04W 56/00

(52) U.S. Cl. CPC H04W 72/1263; H04W 56/0045

(57) ABSTRACT

Method carried out in an access node of a wireless network for scheduling communication with a user equipment, UE, the method comprising: transmitting (720), to the UE, configuration of scheduled periodic communication occasions for communication with the access node: transmitting (730), to the UE, information identifying timing adjustment of the communication occasions in relation to a predetermined periodicity associated with the configuration; and communicating (750) data with the CE using the scheduled periodic communication occasions adjusted based on the timing adjustment.

### TECHNICAL FIELD

This disclosure is related to wireless communication between a wireless device and a wireless network. Specifically, solutions are provided for adapting configuration for periodic scheduling of such communication.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

In the legacy 5G system, traffic with known periodicity and packet size, e.g. voice, is supported using SPS PDSCH (Semi-Persistent Scheduling, Physical Downlink Shared Channel) and CG PUSCH (Configured Grant, Physical Uplink Shared Channel). These types of scheduling of data communication have evolved throughout different releases (Rel) of the 3GPP specifications. In this context, repetitive scheduling may be configured with a period of a certain number of subframes or slots.

While wireless network specifications were originally developed to support voice traffic, communication of data between the UE and the wireless network is nowadays the dominating use case. Moreover, as capacity increases, new types of data transfer and new purposes for data communication continue to emerge. For example, Extended Reality (XR) refer to various types of augmented, virtual, and mixed environments, where human-to-machine and human-to-human communications are performed with the assistance of handheld and wearable end user devices (UEs). XR and Cloud Gaming are considered important for NR (New Radio) Rel-18 and beyond (also known as 5G Advanced). XR traffic is rich in video, especially in the downlink, with a typical frame rate or also known as frame per second (fps) of 60 Hz, which leads to a data transmission with non-integer periodicity in NR. In other words, the periodicity is not an integer number of subframes or slots, and in this example, the periodicity is 16.67 ms. Due to varying frame encoding delay and network transfer time, the packet arrival at the gNB may further experience random jitter. The non-integer and jitter characteristics of XR traffic is known as quasi-periodic traffic. Notably, repetitive scheduling according to current SPS and CG configuration is not designed to accommodate quasi-static periodicity of XR transmissions.

### SUMMARY

An overall objective of the proposed solution is thus to provide improved solutions for scheduling periodic data communication, where communication occasions reoccur based on a predetermined periodicity. An aspect of this objective is to provide solutions that ensures that latency requirements are handled for a wide range of traffic patterns. The proposed solution is defined by the terms of the independent claims, while further advantageous embodiments are set out in the dependent claims and in the detailed description.

According to a first aspect, a method is provided which is carried out in an access node of a wireless network for scheduling communication with a user equipment, UE, the method comprising:

transmitting, to the UE, configuration of scheduled periodic communication occasions for communication with the access node;

transmitting, to the UE, information identifying timing adjustment of the communication occasions in relation to a predetermined periodicity associated with the configuration; and

communicating data with the UE using the scheduled periodic communication occasions adjusted based on the timing adjustment.

An access node of the wireless network comprises:

a transceiver for wireless communication with a user equipment; and

logic circuitry configured to control the access node to carry out the method of the first aspect for scheduling communication with the UE

According to a second aspect, a method is provided which is carried out in a user equipment, UE, for implementing scheduling of communication with an access node of a wireless network, the method comprising:

receiving, from the wireless network, configuration of scheduled periodic communication occasions for communication with the access node;

obtaining information identifying timing adjustment of the communication occasions in relation to a predetermined periodicity associated with the configuration; and

communicating data with the access node using the scheduled periodic communication occasions adjusted based on the timing adjustment.

A user equipment, UE, comprises:

a transceiver for wireless communication with a wireless network; and

logic circuitry configured to control the UE to carry out the method of the second aspect for determining scheduling of communication with an access node of the wireless network.

Based on the proposed solution, a mechanism is obtained for dynamic scheduling of periodic communication between the access node and the UE. The proposed solution obtains inter alia the benefit of facilitating communication of data characterized by non-integer arrival time, by suitable application of timing adjustment of periodic scheduling.

### BRIEF DESCRIPTION THE DRAWINGS

FIG. 1 schematically illustrates an implementation of a wireless communication system, in which a UE communicates with an access node of a wireless network by radio communication.

FIG. 2 schematically illustrates a UE configured to operate with the wireless network according to various examples.

FIG. 3 schematically illustrates an access node configured to operate in the wireless network for communication with the UE according to various examples.

FIG. 4A illustrates an example of dynamic grant scheduling according to 5G NR procedures with multiple acknowledgment feedback.

FIG. 4B illustrates use of resource indicators for multiple acknowledgment feedback.

FIG. 4C illustrates use of a sub-slot based uplink control channel.

FIG. 5 illustrates semi-persistent scheduling with combined acknowledgment feedback.

FIG. 6 schematically illustrates use of periodic scheduling for communication of periodic data traffic with non-integer arrival time.

FIG. 7 is a flowchart of a method for operating an access node according to an embodiment of the proposed solution.

FIG. 8 is a flowchart of a method for operating a UE according to an embodiment of the proposed solution.

FIG. 9 illustrates dynamic scheduling of periodic communication occasions according to one embodiment, based on adjustment applied to a predetermined periodicity.

FIG. 10 illustrates dynamic scheduling of periodic communication occasions according to another embodiment, based on scheduling using at least two periodicities.

FIG. 11 illustrates dynamic scheduling of periodic communication occasions according to another embodiment, based on adjustment of successive communication occasions.

FIG. 12 illustrates dynamic scheduling of periodic communication occasions according to another embodiment, based on use of a rounding function to adjust timing of communication occasions.

FIG. 13 illustrates dynamic scheduling of periodic communication occasions according to another embodiment, based on scheduling of multiple configurations.

FIG. 14 illustrates dynamic scheduling of periodic communication occasions according to the embodiment of FIG. 13, wherein the UE is further configured to monitor at least two configurations.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

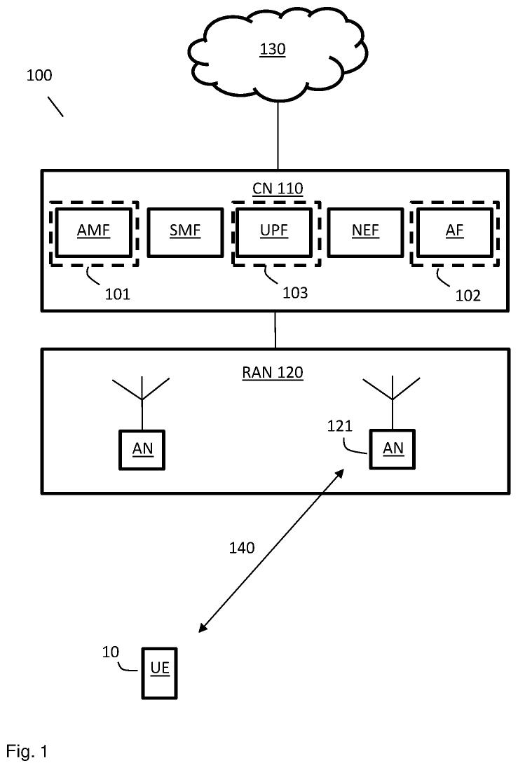

FIG. 1 illustrates a high-level perspective of operation of a UE 10 in a wireless system, configured to communicate with a wireless communication network 100, denoted wireless network 100 for short herein. The wireless network 100 may be a radio communication network 100, configured to operate under the provisions of 5G as specified by 3GPP, according to various examples, or further generations. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the Access and Mobility Management Function (AMF) 101, a Session Management Function (SMF), a User Plane Function (UPF) 103, a Network Exposure Function (NEF), and an Application Function (AF) 102, all of which are legacy functions of the 5G system. The AF(s) may also be deployed outside of the 5G system i.e. as an application running on an application server connected to the external network e.g. the Internet.

The core network 110 is connected to at least one access network 120, also referred to as a Radio Access Network (RAN), comprising one or more base stations or access nodes, of which one access nodes 121 is illustrated. The access node 121 is a radio node configured for wireless communication on a physical channel 140 with various UEs. The physical channel 140 may be used for setting up one or more logical channels between UEs and the wireless network, such as with the AMF.

Before discussing further details and aspects of the proposed method, functional elements for examples of the entities involved in carrying out the proposed solution will be briefly discussed, including the access node 121 and the UE 10.

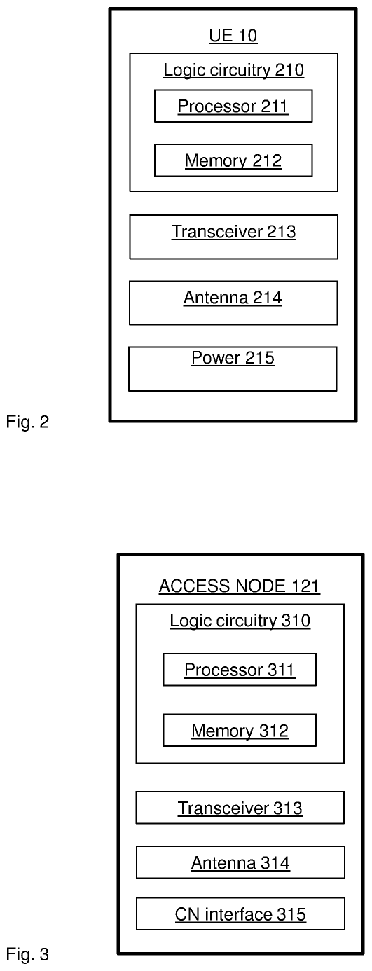

FIG. 2 schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 (e.g., a battery) that provides energy to the other components of the UE 10.

FIG. 3 schematically illustrates a radio node in the form of an access node 121 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on the physical channel 140. The logic circuitry 310 may realize a scheduler for scheduling repetitive communication according to the solutions proposed herein, and for configuring the UE to operate according to the scheduling.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an isotropic sensitivity profile of the antenna array to transmit radio signals in a particular transmit direction. The access node 121 may further comprise an interface 315, configured for communication with the core network 110. Obviously, the access node 121 may include other features and elements than those shown in the drawing or described herein, such as a power supply and a casing etc.

Various aspects of legacy 5G transmission and scheduling will now be provided, to which various aspects of the proposed solution are associated. For the sake of simplicity, the description will be focused on DL transmission using PDSCH, whereas corresponding arrangements exist for UL transmission using PUSCH. PDSCH is a downlink physical channel used to carry application data and higher layer control messages. The PDSCH can be transmitted using Dynamic Grant (DG) or via Semi-Persistent Scheduling (SPS).

In a Dynamic Grant PDSCH (DG-PDSCH), the PDSCH resource is dynamically indicated by the gNB using a DL Grant carried by a DCI (Downlink Control Indicator) transmitted in a defined resource on the Physical Downlink Control Channel (PDCCH).

PDSCH is transmitted using HARQ (Hybrid Automatic Repeat reQuest) transmission, where for a PDSCH ending in slot n, the corresponding PUCCH carrying the HARQ-ACK is transmitted in slot n+K1. In Dynamic Grant PDSCH, the value of K1 is indicated in the field “PDSCH-to-HARQ_feedback timing indicator” of the DL Grant (carried by DCI Format 1_0, DCI Format 1_1 or DCI Format 1_2). Multiple (different) PDSCHs can point to the same slot for transmission of their respective HARQ-ACKs and these HARQ-ACKs (in the same slot) are multiplexed into a single PUCCH. Hence a PUCCH can contain multiple HARQ-ACKs for multiple PDSCHs.

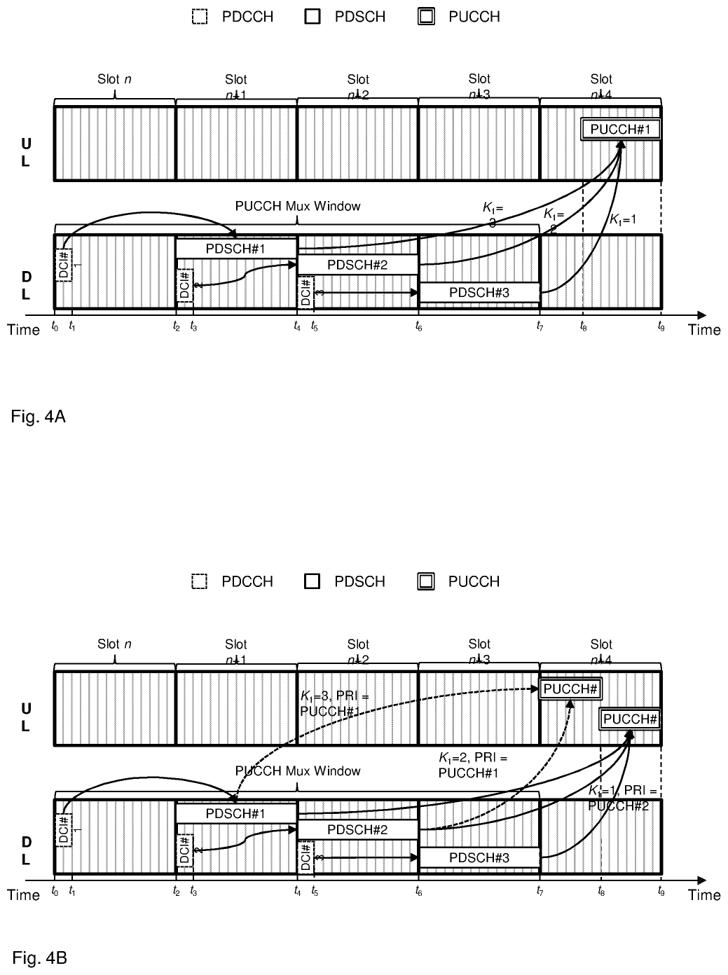

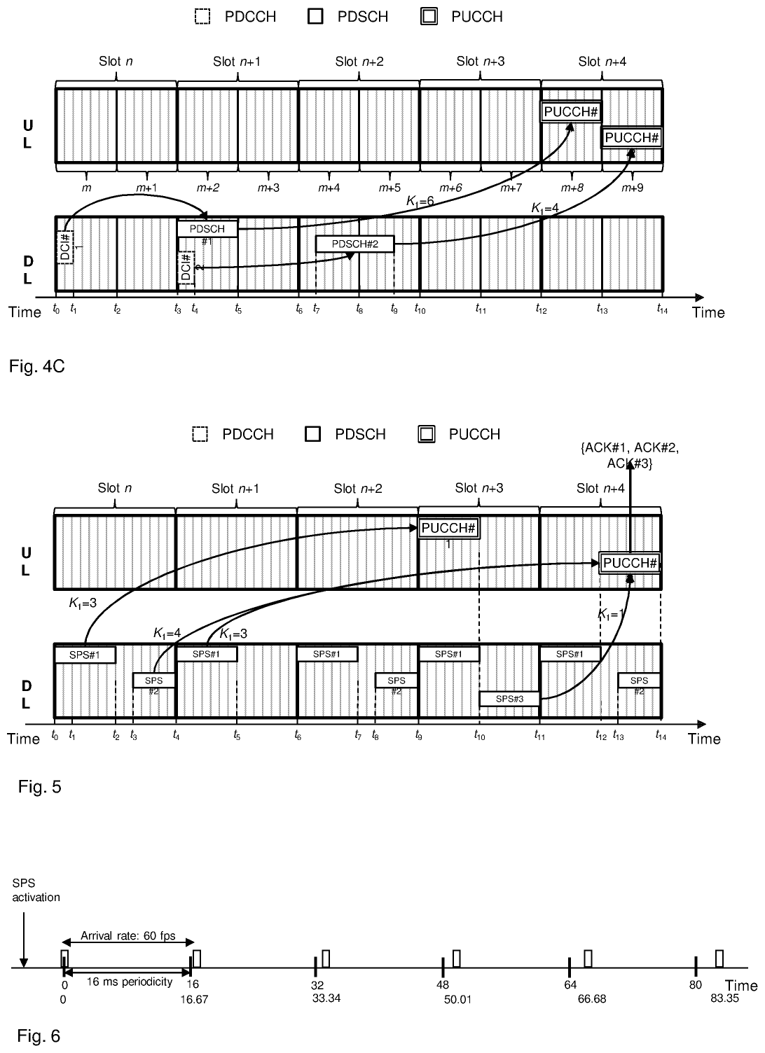

FIG. 4A shows an example where 3 DL Grants are transmitted to the UE via DCI#1, DCI#2 and DCI#3 in slot n, n+1 and n+2 respectively. DCI#1, DCI#2 and DCI#3 schedule PDSCH#1, PDSCH#2 and PDSCH#3 respectively. DCI#1, DCI#2 and DCI#3 further indicate K1=3, K1=2 and K1=1 respectively. Since the K1 values indicate that the HARQ-ACK feedbacks for PDSCH#1, PDSCH#2 and PDSCH#3 are transmitted in slot n+4, the UE multiplexes all of these HARQ-ACKs into a single PUCCH transmission, i.e. PUCCH#1. The PUCCH Multiplexing Window is a time window where PDSCHs can be multiplexed into that PUCCH and the size of the PUCCH multiplexing window depends on the range of K1 values. In the example in FIG. 3A, the PUCCH Multiplexing Window is from Slot n to Slot n+3, which means the max K1 value is 4 slots.

In Rel-15, only one PUCCH per slot is allowed to carry HARQ-ACKs for the same UE even if the different PUCCHs do not overlap in time. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received.

FIG. 4B shows an example where DCI#1 and DCI#2 indicate PUCCH#1 for the HARQ-ACKs corresponding to PDSCH#1 and PDSCH#2, but DCI#3 indicates PUCCH#2 for the HARQ-ACK corresponding to PDSCH#3. Here, PUCCH#1 and PUCCH#2 do not overlap in time. Since DCI#3 schedules the last PDSCH, i.e. PDSCH#3, in the Multiplexing Window, the UE will use PUCCH#2 to carry the HARQ-ACK for PDSCH#1, PDSCH#2 and PDSCH#3. NOTE: PUCCH carrying other UCI such as SR (Scheduling Request) can be transmitted separately to a PUCCH carrying HARQ-ACK within the same slot if they do not overlap in time.

In Rel-16, particularly to support eURLLC (enhanced Ultra Reliable Low Latency Communication), sub-slot PUCCH is introduced for carrying HARQ-ACK for URLLC PDSCH. Sub-slot based PUCCH allows more than one PUCCH carrying HARQ-ACKs to be transmitted within a slot. This gives more opportunity for PUCCH carrying HARQ-ACK for PDSCH to be transmitted within a slot, thereby reducing latency for HARQ-ACK feedbacks. In a sub-slot based PUCCH, the granularity of the K1 parameter, identifying the time difference between the end of PDSCH and the start of its corresponding PUCCH, is in units of sub-slot instead of slot, where the sub-slot size can be 2 symbols or 7 symbols.

FIG. 4C shows an example where the sub-slot size=7 symbols (i.e. half a slot) and the sub-slots are labelled as m, m+1, m+2, etc. PDSCH#1 is transmitted in slot n+1 but for sub-slot based HARQ-ACK PUCCH, it is considered to be transmitted in sub-slot m+2 and here K1=6 which means that the corresponding HARQ-ACK is in sub-slot m+2+K1=m+8. PDSCH#2 is transmitted in slot n+2 but occupies sub-slots m+4 and m+5. The reference for K1 is relative to the sub-slot where the PDSCH ends and in this case PDSCH#2 ends in sub-slot m+5. The DL Grant in DCI#2 that schedules PDSCH#2 indicates K1=4 which schedules a PUCCH for its HARQ-ACK at sub-slot m+5+K1 =sub-slot m+9.

In Semi-Persistent Scheduling (SPS) PDSCH, the PDSCH resources are RRC (Radio Resource Control) configured and occur periodically where each SPS PDSCH occasion has a pre-configured and fixed duration. The SPS PDSCH configuration of the legacy Rel-16 is provided in 3GPP Technical Specifications TS 38.331 version 16.7.0 section 6.3.2. This allows the gNB to schedule traffic that has a known periodicity and packet size. The gNB may or may not transmit any PDSCH in the SPS PDSCH occasion but the UE needs to monitor each SPS PDSCH occasion for potential PDSCH transmission.

In Rel-15 the UE can only be configured with one SPS PDSCH and this SPS PDSCH is activated using an activation DCI (Format 1_0 or 1_1) with the CRC (Cyclic Redundancy Check) scrambled with CS-RNTI (Configured Scheduling, Radio Network Temporary Identifier) as described in TS 38.212 v15.13.0 section 7.3. Once an SPS PDSCH is activated, the UE will monitor for potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI but no HARQ-ACK feedback is provided for an activation DCI.

Similar to DG-PDSCH, the slot containing the PUCCH resource for HARQ-ACK corresponding to SPS PDSCH is indicated using the K1 value in the field “PDSCH-to-HARQ_feedback timing indicator” of the activation DCI. Since DL Grant is not used for SPS PDSCH, this K1 value is applied for every SPS PDSCH occasion and can only be updated after it has been deactivated and re-activated using another activation DCI with a different K1 value. The activation DCI also schedules the MCS (Modulation and Coding Scheme), time (TDRA) and frequency (FDRA) resources within the periodic subframe of the PDSCH. Since there is only 1 SPS PDSCH, PUCCH Format 0 or 1 is used to carry the HARQ-ACK feedback. If the PUCCH collides with a PUCCH carrying HARQ-ACK feedbacks for DG-PDSCH, the HARQ-ACK for SPS PDSCH is multiplexed into the PUCCH corresponding to DG-PDSCH.

In Rel-16 the UE can independently be configured with up to eight SPS PDSCHs, where each SPS PDSCH has an SPS Configuration Index that is RRC configured. Each SPS PDSCH is individually activated using a DCI (Format 1_0, 1_1 & 1_2) with the CRC scrambled with CS-RNTI, where it indicates the SPS Configuration Index of the SPS PDSCH to be activated. However, multiple SPS PDSCHs can be deactivated using a single deactivation DCI. Similar to Rel-15, the UE provides a HARQ-ACK feedback for the deactivation DCI but does not provide one for the activation DCI.

The slot or sub-slot containing the PUCCH resource for HARQ-ACK feedback corresponding to a SPS PDSCH occasion is determined using the K1 value indicated in the activation DCI. Since each SPS PDSCH configuration is individually activated, different SPS PDSCH can be indicated with different K1 values.

Since different K1 values can be used for different SPS PDSCH configurations, it is possible that the HARQ-ACK for multiple SPS PDSCHs point to the same slot or sub-slot and in such a scenario, these HARQ-ACKs are multiplexed into a single PUCCH. For multiple SPS PDSCH configurations, PUCCH Format 2, 3 & 4 (in addition to PUCCH Format 0 & 1) can be used to carry multiple HARQ-ACKs for SPS PDSCH. Here the HARQ-ACKs in the PUCCH are sorted in ascending order according to the DL slot for each of the SPS PDSCH Configuration Indices and then sorted in ascending order of the SPS PDSCH Configuration Index. Since typically the K1 value is fixed per SPS PDSCH then it is unlikely to have two or more SPS PDSCHs with the same index multiplexed into a PUCCH.

FIG. 5 shows an example of Rel-16 SPS, where a UE is configured with 3 SPS PDSCHs labelled as SPS#1, SPS#2 and SPS#3 with different periodicities that are RRC configured with SPS Configuration Index 1, 2 and 3 respectively. SPS#1, SPS#2 and SPS#3 are activated with K1=3, K1=4 and K1=1 respectively. These K1 values result in the PUCCH for HARQ-ACK feedbacks corresponding to SPS#2 in Slot n, SPS#1 in Slot n+1 and SPS#3 in Slot n+3 being in the same slot, i.e. carried by PUCCH#2 in Slot n+4. PUCCH#2 therefore provides 3 HARQ-ACKs labelled as {ACK#1, ACK#2, ACK#3} for SPS#1, SPS#2 and SPS#3 respectively according to their SPS PDSCH Configuration Indices (note that in this example, there is only one unique SPS PDSCH per DL slot that have HARQ-ACK multiplexed into PUCCH#2). When the PUCCH for SPS PDSCHs collides with PUCCH for DG-PDSCH, their HARQ-ACKs are multiplexed where the SPS PDSCH HARQ-ACKs are appended after those for DG-PDSCH.

As has been noted earlier, some applications, e.g. XR, may require a transmission with non-integer periodicity. An XR transmission with 60 fps requires a transmission with 16.67 ms. Furthermore, XR is a delay sensitive application. A certain delay in the transmission can reduce user experience. Large size of data buffering which could be used to re-arrange the transmission may not be possible as it may introduce significant delay.

In accordance with what has been described above, legacy 5G NR uses SPS and Configured Grant to handle periodic transmission. Hence, the usage of control channel can be minimized and resulting in improving capacity. However, legacy SPS periodicity is using a selected integer number as shown below:

SPS-config=periodicity ENUMERATED {ms10, ms20, ms32, ms40, ms64, ms80, ms128, ms160, ms320, ms640, spareX}

FIG. 6 illustrates, by way of example, the resulting mismatch between a legacy SPS allocation pattern using a 16 ms periodicity and a traffic pattern with 60 frames per second, resulting in a 16.67 ms periodicity. Had instead an SPS allocation pattern with a periodicity of 17 ms been configured, the corresponding mismatch problem would still occur. Notably, the mismatch gets accumulated over time. This illustrates that current SPS configuration is not designed to accommodate quasi-static periodicity of data traffic, for instance various forms of XR transmissions.

The proposed solution is based on the notion of providing timing adjustment to obtain dynamic scheduling of periodic communication so that it can support quasi-static periodicity of e.g. XR transmissions by ensuring fair usage of resources. Going forward, this will occasionally be referred to as dynamic SPS configuration, although it shall be understood that this is also applicable for scheduling periodic UL communication, corresponding to CG. Specifically, the proposed solution provides for dynamic SPS where communication occasions are automatically adjusted without occasion-specific indications. In contrast to the legacy method which for example has a fixed periodicity, the periodicity is automatically adjusted based on a predefined method such that the access node 121 and UE 10 know the timing of the communication occasions.

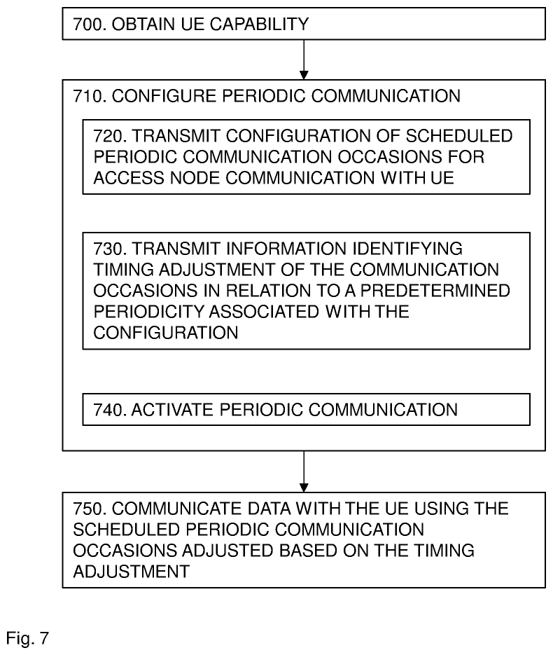

FIG. 7 shows a flowchart of a general presentation of a method carried out in the access node 121 of a wireless network 100, according to the proposed solution.

In optional step 700 the access node 121 obtains UE capability information, either from the UE 10 or from within the wireless network 100. In addition to legacy reporting of UE capabilities, the information obtained in step 700 may in various embodiments comprise information with regard to how many different periodic configurations the UE 10 may concurrently support and monitor, as will be described further below.

In step 710 the access node 121 configures the UE for periodic communication. This comprises transmitting 720, to the UE 10, configuration of scheduled periodic communication occasions for communication with the access node 121. In the context of this disclosure, scheduled periodic communication occasions refers to resources allocated for communication in DL or UL, which reoccur on a periodic basis. Such communication is identified and can be activated or even deactivated by signaling from the access node 121 to the UE 10, wherein the allocated resources are periodically monitored and potentially used (e.g. monitored by the UE 10 and used by the access node 121 for the example of DL communication) without requiring further indication before each communication occasion. Examples of legacy proceedings provide that PDSCH is used for scheduled periodic communication occasions in SPS, and PUSCH is used for scheduled periodic communication occasions in CG.

Configuring the UE 10 may be carried out by transmitting radio resource control (RRC) signaling, e.g. according to legacy procedures. As an alternative, the UE 10 may be pre-configured with the configuration, by specified default, or arranged to determine the configuration based on other input, such as based on characteristics of data to be received, e.g. identified by an initiated application type. The configuration comprises radio configuration including time and frequency data and at least one associated periodicity for determining re-occurrence of the scheduled periodic communication occasions.

Configuring the UE 10 for periodic communication further comprises transmitting 730, to the UE, information identifying timing adjustment of the communication occasions in relation to a predetermined periodicity associated with the configuration. This may entail delaying or advancing scheduling of communication occasions compared to a configured predetermined periodicity, or by adjusting timing of the communication occasions to improve alignment of the communication occasions with a known predetermined non-integer periodicity, as will be outlined by way of examples going forward.

In some embodiments, the information identifying timing adjustment may be comprised in the configuration. In other embodiments, the information is provided in conjunction with activation 740, by the access node 121, of the periodic scheduling. Hence, in order to obtain provide full configuration, some configuration parameters may be indicated to the UE 10 by said information in the activation DCI, such as when a certain SPS configuration index is activated. The access node 121 may also transmit deactivation of a configured SPS configuration, e.g. by DCI, as mentioned in the foregoing.

In step 750, the access node 121 communicates data with the UE 10 using the scheduled periodic communication occasions adjusted based on the timing adjustment. In this context, the data is communicated in resources for the communication occasions that may be shifted in time, either delayed or advanced, in relation to the periodic timing identified by the predetermined periodicity.

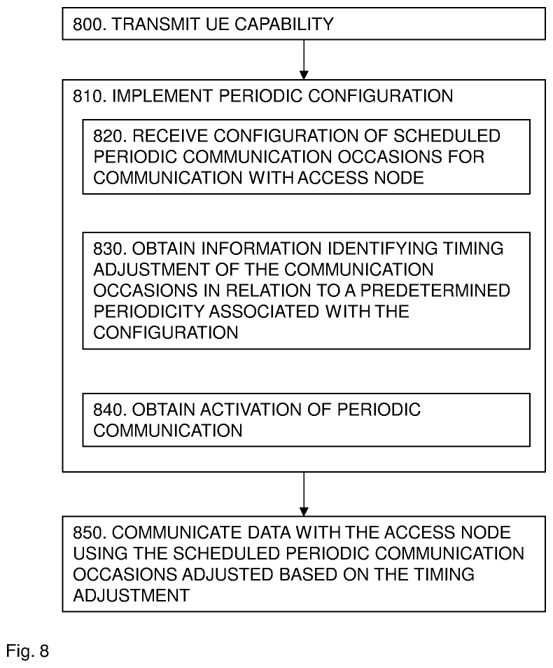

FIG. 8 shows a flowchart of a general presentation of a method carried out in the UE 10 according to the proposed solution.

In optional step 800, the UE 10 transmits UE capability information to the wireless network 100, for obtainment in the access node 121. In addition to legacy reporting of UE capabilities, the capability information provided in step 800 may in various embodiments comprise information with regard to how many different periodic configurations the UE 10 may concurrently support and monitor, as will be described further below.

In step 810 the UE 10 is configured by the access node 121 for periodic communication. This comprises receiving 820 configuration of scheduled periodic communication occasions for communication with the access node 121. This may be received from the access node 121 to which the UE 10 is connected. Alternatively, configuration which the access node 121 may activate and use may have been transmitted to the UE 10, and be stored therein, from another access node of the wireless network 100 at an earlier time, when the UE 10 was connected to that other access node. The configuration may be received by radio resource control (RRC) signaling, e.g. according to legacy procedures. As an alternative, the UE 10 may be pre-configured with the configuration, by specified default, or arranged to determine the configuration based on other input, such as based on characteristics of data to be received, e.g. identified by an initiated application type. The configuration comprises radio configuration including time and frequency data and at least one associated periodicity for determining re-occurrence of the scheduled periodic communication occasions.

The method further comprises obtaining 830 information identifying timing adjustment of the communication occasions in relation to a predetermined periodicity associated with the configuration. This step 830 may comprise receiving the information from the access node 121. In an alternative embodiment, this information may be obtained in the UE 10 from an application layer, based on characteristics such as periodicity of a data traffic pattern of application data, e.g. frame rate.

In some embodiments, the information identifying timing adjustment may be obtained in the configuration. In other embodiments, the information is provided in conjunction with activation 840, by the access node 121 or from the application layer, of the periodic scheduling. Hence, obtainment of full configuration may comprise receiving some configuration parameters indicated by the access node 121 by said information in the activation DCI, such as when a certain SPS configuration index is activated.

In step 850, the UE 10 communicates data with the access node 121 using the scheduled periodic communication occasions adjusted based on the timing adjustment.

By means of the proposed solution, the UE 10 is configured to carry out periodic communication with the access node 121 with an adjusted periodicity, which may be specifically configured to adapt timing of the communication occasions to accommodate to an associated periodicity of data to be communicated, such as a data traffic frame rate. The result is that scheduling is obtained which is tailored to the periodic context of the data traffic to be communicated, thus ensuring that latency requirements can be upheld, while avoiding added control signaling to adapt the scheduling.

As already noted, the proposed solution is applicable for periodic scheduling of DL data traffic, wherein communicating data comprises transmitting data from the access node 121 to the UE 10. This corresponds to improvements in Semi-Persistent Scheduling (SPS). Alternatively, or additionally, the proposed solution is applicable for periodic scheduling of UL data traffic, wherein communicating data comprises receiving data in the access node 121 from the UE 10. This corresponds to improvements in Configured Grant (CG). Nevertheless, in both of these cases the configuration identifies semi-persistent scheduling (SPS), applied in either DL or UL. For the sake of simplicity, the description will be directed to the example of scheduling of DL resources, corresponding to improvements in the legacy SPS.

Various embodiments which highlight different features and advantages of the proposed solution will now be described with reference to the drawings. It may be noted that in these drawings, for the sake of clarity, the scheduled and adjusted timing of communication occasions is indicated over the time axis, whereas the periodic data traffic pattern, which may have a non-integer periodicity, is illustrated below the time axis. This vertical distinction between the communication occasions and the arriving data traffic to be communicated shall thus not be confused with any frequency division.

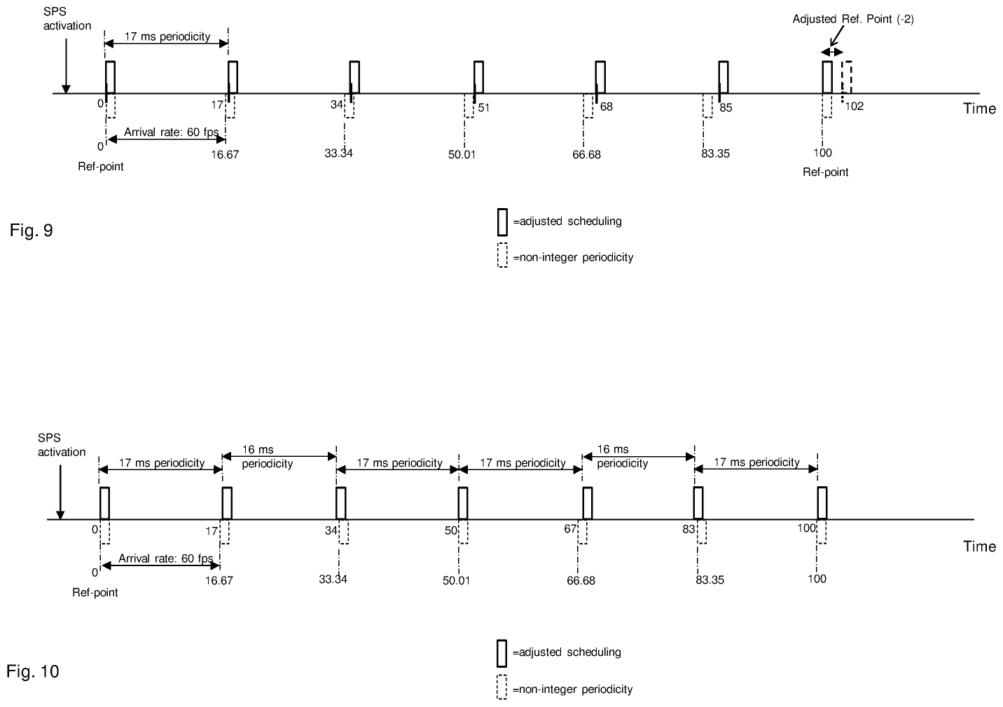

FIG. 9 illustrates scheduling according to an embodiment, wherein the obtained configuration, cf. steps 720, 820, identifies the predetermined periodicity. As noted, the periodicity may in this context be provided in an RRC layer message or indicator. The information identifying timing adjustment comprises at least one adjustment parameter to be applied to the communication occasions. In some embodiments, information identifying the timing adjustment may also be provided by RRC signaling, such as by a new RRC parameter as part of the SPS configuration. In other embodiments, the information identifying the timing adjustment is part of Downlink Control Information (DCI). In this embodiment, the information may be conveyed upon activation 740, 840 of the periodic scheduling.

According to some examples, the periodicity of the configuration is set to an integer value based on a data traffic pattern such as an XR frame rate or any other application. The access node 121 may e.g. set the periodicity based on a rule that defines a nearest integer periodicity, or to a periodicity with a nearest longer integer period compared to a non-integer period of arrival of the traffic data. The integer periodicity may be in units of slot or sub-slot. Note: In Rel-16, the periodicity can be configured in units of slots where a slot duration can be 1 ms, 0.5 ms, 0.25 ms depending on the sub-carrier spacing of the transmission.

According to the embodiment of FIG. 9, the periodic SPS is set to 17 ms. Here, the non-integer periodicity of the data traffic is a frame rate of 60 frame per second (fps), corresponding to a period of 16.67 ms. With the 17 ms periodicity, communication occasions occur at (starting from 0) 17, 34,51, 68 ms as shown in the drawing. The adjustment parameter may in this context refer to a buffer time between the non-integer packet arrival and the associated communication occasion. When the buffer time exceeds a certain value, e.g. 2 ms, the periodicity is reset, or adjusted minus 2, so that next communication occasion comes at 85+17−2=100 ms. Based on the known SPS periodicity and its relation to a certain data traffic frame rate, the adjustment parameter may be preconfigured. With reference to the example of FIG. 9, the adjustment parameter comprises a time shift and an adjustment interval identifying a number of cycles of communication occasions between adjustment using the time shift. Here, the time shift is adjust_Refvalue=−2 ms, and the adjustment interval adjust_cycle parameter=6 identifies that the adjustment is made every 6 cycles. It should be appreciated that the adjust_Refvalue can be positive or negative, and also that the proposed solution is not restricted to units of ms but it can be in finer units of time, e.g. in units of slot (which can be less than 1 ms) or sub-slot.

In the context of this embodiment, the information identifying timing adjustment may identify a reference point in time for application of the timing adjustment to the communication occasions. An initial reference point may be provided upon SPS activation, 740, 840. Application of the time shift provides a new, adjusted, reference point.

According to an alternative to the embodiment of FIG. 9, the periodicity of the configuration is instead set to 16 ms. In this alternative, for the case with fps=60, the UE 10 can be configured with an adjustment parameter identifying adjust_Refvalue=4 ms and adjust_cycle parameter=6. Here, the gNB transmits in every 16 ms according to the SPS periodicity from a reference point. However, there is a cycle or interval that provides that every 6 communication occasion there is a new reference point that is adjusted 4 ms. FIG. 10 illustrates scheduling according to another embodiment, wherein the obtained configuration, cf. steps 720, 820, identifies the predetermined periodicity. Specifically, the predetermined periodicity comprises a first periodicity and a second periodicity. As noted, the predetermined periodicity may in this context be provided in an RRC layer message or indicator. The information identifying timing adjustment comprises at least one adjustment parameter to be applied to the communication occasions. Specifically, the adjustment parameter identifies timing for switching between the first periodicity and the second periodicity. In some embodiments, information identifying the timing adjustment may also be provided by RRC signaling, such as by a new RRC parameter as part of the SPS configuration. In other embodiments, the information identifying the timing adjustment is part of Downlink Control Information (DCI). In this embodiment, the information may be conveyed upon activation 740, 840 of the periodic scheduling.

In the example of FIG. 10 the UE 10 is thus provided with more than one periodicity and the UE 10 (and the access node 121) changes the periodicity according to a predefined order. In the shown example, the UE 10 is configured with a first periodicity of 16 ms and a second periodicity of 17 ms, wherein the adjustment parameter identifies timing for switching or alternating between these two periodicities. In some examples, the timing for switching comprises a timing scheme, identifying a number of communication occasions for using one of the first and second periodicities before switching. According to the example shown in FIG. 10, the adjustment parameter thus provides a timing scheme based on a reference point t=n, upon which the UE is scheduled to monitor a first communication occasion, at time t=n+17 based on the second periodicity for monitoring a 2nd communication occasion, a time t=n+17+16 based on the first periodicity for monitoring the 3rd communication occasion, a time t=n+17+16+17 based on the second periodicity for monitoring a 4th communication occasion and so on. It should be appreciated that more than two periodicities can be configured, and that the order in which the periodicities change can be specified, e.g. every 4 cycles UE uses first periodicity, followed by the second periodicity in the next 10 cycles, then the 3rd periodicity in the next 2 cycles and back to the 1st periodicity, etc.

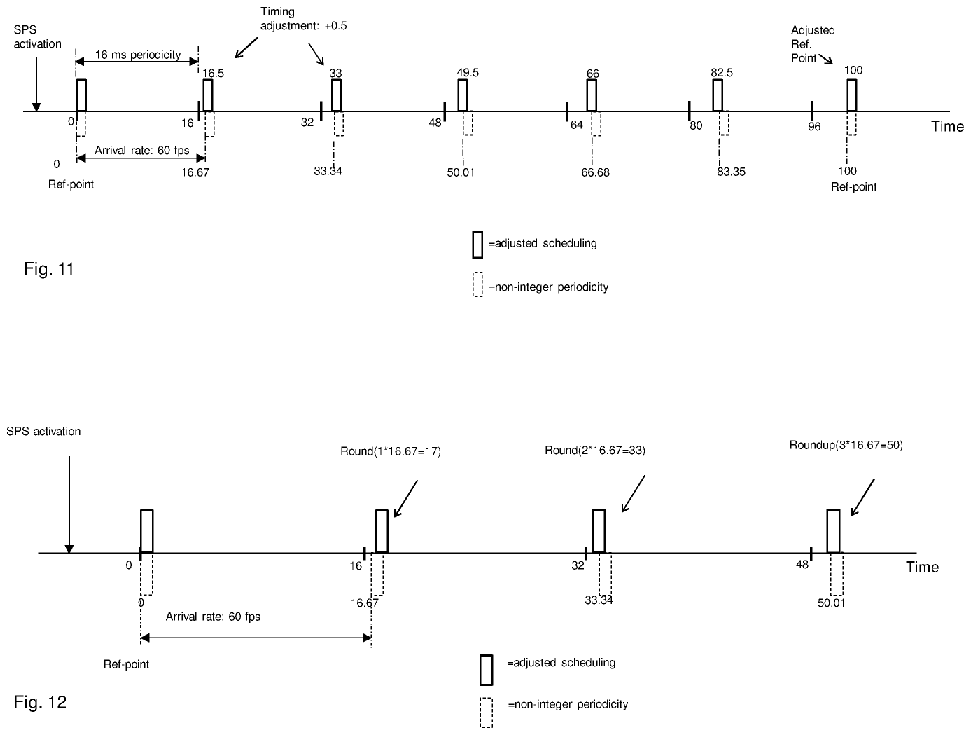

FIG. 11 illustrates another embodiment wherein the obtained configuration, cf. steps 720, 820, identifies the predetermined periodicity. As noted, the predetermined periodicity may in this context be provided in an RRC layer message or indicator. The information identifying timing adjustment comprises at least one adjustment parameter to be applied to the communication occasions. Specifically, the adjustment parameter identifies timing adjustment to be applied to successive communication occasions of the predetermined periodicity for determining an adjusted periodicity between the communication occasions. In some embodiments, information identifying the timing adjustment may also be provided by RRC signaling, such as by a new RRC parameter as part of the SPS configuration. In other embodiments, the information identifying the timing adjustment is part of Downlink Control Information (DCI). In this embodiment, the information may be conveyed upon activation 740, 840 of the periodic scheduling.

In the embodiment of FIG. 11, the adjustment parameter is introduced with the purpose of adjusting legacy/existing periodicity to a new periodicity. Hence, it provides more flexibility rather than adding a fixed new periodicity. The new parameter, for example SPS_period_adjust, is used for timing adjustment of successive communication occasions. For example, a legacy SPS periodicity of 16 ms may be configured, wherein the adjustment parameter provides SPS_period_adjust=0.5 ms. this may be used for e.g. Rel-15/16 UEs, which as such cannot be configured with a 16.5 ms periodicity. Here, the UE 10 nevertheless interprets the new periodicity is 16.5 ms. The unit of the adjustment parameter can also be in sub-slot, where for example, a sub-slot can be 2 OFDM symbols or 7 OFDM symbols instead of in units of ms or fraction of a slot/sub-slot. Similar to what has been outlined for FIG. 9, the adjustment parameter may further comprise a time shift for setting a new reference point, and an adjustment range determining the number of said successive communication occasions before adjusting the reference time. This is also as indicated in FIG. 11, where adjust_cycle parameter=5 and wherein adjust_Refvalue=+4 ms for the next communication occasion based on the periodicity of 16 ms.

FIG. 12 illustrates another embodiment wherein the predetermined periodicity may be provided either in the obtained configuration, cf. steps 720, 820, or in the information identifying timing adjustment of the communication occasions, cf. 730, 830. As noted, the predetermined periodicity may in this context be provided in an RRC layer message or indicator. In some embodiments, information identifying the timing adjustment may also be provided by RRC signaling, such as by a new RRC parameter as part of the SPS configuration. In other embodiments, the information identifying the timing adjustment is part of Downlink Control Information (DCI). In this embodiment, the information may be conveyed upon activation 740, 840 of the periodic scheduling.

In accordance with the embodiment exemplified in FIG. 12, the access node 121 provides information associated with the predetermined periodicity of the traffic patterns of the data. The predetermined periodicity thus identifies a non-integer time of arrival, in a unit of time, based on an associated traffic rate. The timing adjustment further determines communication occasion timing at an integer number of time by rounding off the non-integer time of arrival based on a rounding function. The rounding function may as such provided in the configuration, or be specified and pre-configured in the UE. Use of the rounding function may further be identified by the configuration, or be identified upon SPS activation.

In the drawing, the access node 121 provides SPS activation to the UE 10. Unlike the legacy SPS where the period of SPS (e.g., 10 ms) is configured, the access node 121 provides the information identifying the timing adjustment based on a non-integer periodicity. In the shown example, the timing adjustment identifies a periodicity=Arriv_60_fps. The UE 10 may be configured to interpret this information so that the first communication occasion is identified as a reference point. Subsequent communication occasions are adjusted according to a predefined equation. The predefined equation may provide a rounding function, e.g. round (N*1/fps), where N is the index of the communication occasions. In the shown example, based on the predetermined periodicity of 60 fps, the adjusted timing of the communication occasions becomes (Oms, 17 ms, 33 ms, 50 ms). The access node 121 and the UE 10 are thus both configured to determine the adjusted scheduling for the communication. The rounding function may be configured or pre-determined to round up or round down to the nearest integer value.

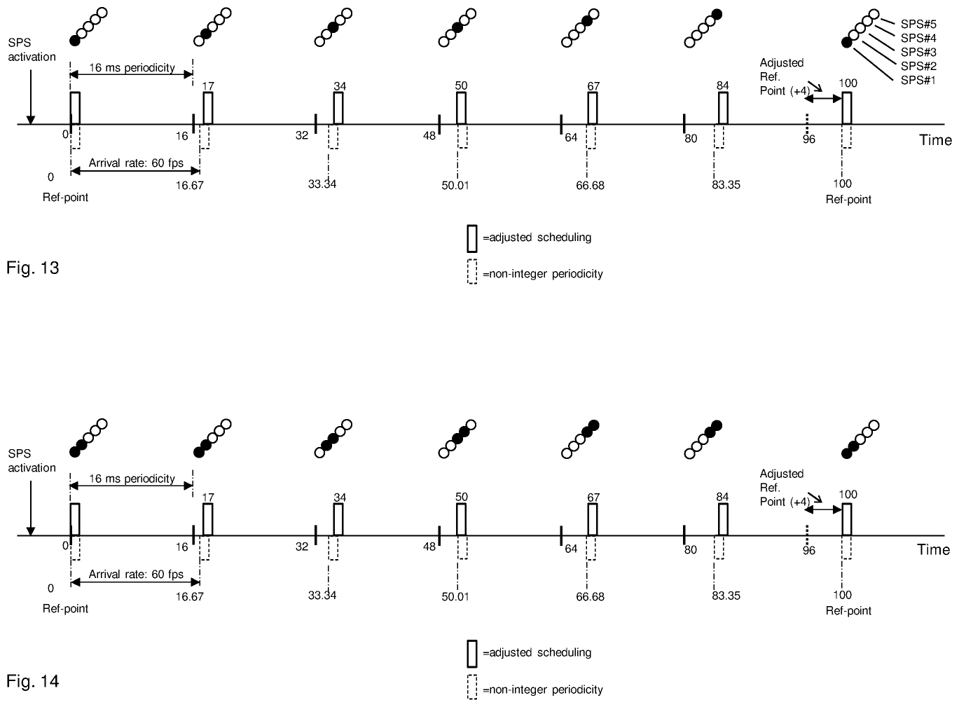

FIG. 13 illustrates scheduling according to an embodiment, wherein the obtained configuration, cf. steps 720, 820, identifies the predetermined periodicity. Specifically, said configuration comprises a plurality of configurations. As noted, the periodicity may in this context be provided in an RRC layer message or indicator. The information identifying timing adjustment identifies alternate scheduling of communication occasions among said plurality of configurations. In some embodiments, information identifying the timing adjustment may also be provided by RRC signaling, such as by a new parameter as part of the SPS configuration. In other embodiments, the information identifying the timing adjustment is part of Downlink Control Information (DCI). In this embodiment, the information may be conveyed upon activation 740, 840 of the periodic scheduling.

The UE 10 is thus configured with multiple SPS configurations, i.e., a set of SPS configuration, wherein the UE 10 is further configured to know which configuration shall be used, i.e. monitored and/or used for communication, in each period. The UE can be informed on the monitored SPS within a set of SPSs or the UE is pre-configured with a certain pattern. This is, as for the other embodiments, based on the traffic pattern being deterministic in terms of expected arrival rate, e.g., fps=60.

In the example of FIG. 13, the UE 10 is configured for use with a traffic data rate of fps=60. The UE 10 is configured with a plurality of configurations having a common periodicity, with a time offset between the communication occasions for said plurality of configurations. In the shown example, 5 configurations are configured with a 16 ms periodicity, in which there is an offset of 1 ms for each configuration. From one scheduled occasion at configuration SPS#1, the time to the next communication occasion in the following period is thus different dependent on which configuration is used: [SPS#1: 16 ms, SPS#2: 17 ms, SPS#3: 18 ms, SPS#4: 19 ms, SPS#5: 20 ms].

The access node 121 may be expected to only use one SPS configuration in each period. Based on the multiple configurations with a common periodicity and the identified time offset, the UE 10 is controlled, by means of the information identifying timing adjustment, to apply a certain scheme for monitoring SPS. According to the example shown in the drawing, the UE 10 is controlled to apply the scheme {1,2,3,3,4,5}, where each number identifies the SPS configuration, and the order identifies the cycles/periods. The adjusted timing of the communication occasion obtained by this scheme is indicated above each box above the timeline. The reference point for the next communication occasion, after the provided sequence, is adjusted by 4 ms and the activated SPS subsequently follow the same pattern. The adjustment of the reference point may also be pre-configured with the sequence, and identified by the information identifying timing adjustment. In an alternative embodiment, the UE 10 is informed explicitly on the monitored SPS for each period, regarding which configuration to monitor in the next cycle.

FIG. 14 illustrates a variant of the embodiment of FIG. 13. In FIG. 13, the UE 10 is configured to monitor only one configuration in each communication occasion. In order to provide access node flexibility, the UE 10 can be configured to monitor more than 1 SPS in each SPS occasion, i.e. to monitor the communication occasions as determined based on more than one configuration for the same cycle/period. In the example of FIG. 14, the monitored SPS within a cycle are SPS config {(1,2), (1,2), (2,3), (3,4), (4,5), (4,5)}.

The UE 10 thus always monitors two (or more, in further alternatives) SPS configurations in each communication occasion. However, the access node 121 only uses one of them. The cost would be that the UE 10 may need to decode unnecessary resource when the access node 121 does not transmit. On the other hand, in addition to providing access node flexibility, this embodiment provides increased capability of fulfilling latency requirements when the traffic data is further affected by jitter.

With respect to the embodiments of FIGS. 13 and 14, the UE must be able to make use of more than one SPS configuration concurrently, and/or be able to switch between SPS configurations at the rate at least matches the predetermined periodicity. According to some examples, an indication of supported maximum number of configurations for communication of data or for monitoring for communication of data is thus provided in UE capability information, or as corresponding information, which the UE 10 reports to the wireless network 100, cf. 700, 800. Some UEs may have better capability (e.g., advanced UE, premium UE) in term of the make use of concurrent SPS configuration than other UEs. Based on this capability information, the access node 121 may decide whether or not to activate SPS using multiple configurations with the UE 10.

In another embodiment, the UE may obtain the information identifying timing adjustment from the application layer, rather than from the access node 121. Where the predetermined periodicity identifies a non-integer period, e.g. 16.67 ms, the UE is configured to autonomously determine when it needs to apply the timing adjustment according to any of the examples provided herein. For example, the UE 10 may be pre-configured to know that the SPS_adjustment_offset is configured to −1 ms and that the legacy SPS_periodicity=17 ms. The UE 10 can calculate that after 3 cycles the gap between the non-integer arrival and the start of the next communication occasion according to the 17 ms periodicity would be equals to or greater than 1 ms, and thereby be triggered to apply the SPS_adjustment_offset of −1 ms. In other words, instead of being exactly when to apply the SPS_adjustment_offset, the UE 10 determines when to apply the SPS_adjustment_offset.

Various aspects of the proposed solution have been outlined in the foregoing. The proposed solution relates to dynamic scheduling of periodic communication, such as SPS, in which both the access node 121 and the UE 10 are aware and apply common timing adjustment. This is typically useful for handling data traffic with non-integer arrival time. For the DL case, the access node 121 is aware when the communication occasion, e.g. PDSCH, is transmitted and the UE 10 is aware when the data should be received or when to monitor the SPS occasion. The proposed dynamic SPS is nevertheless applicable to both UL and DL transmission, corresponding to legacy terms DL-SPS PDSCH and CG-PUSCH.

The dynamic SPS transmission can be achieved by one or more of the described techniques, which have been exemplified with reference to the drawings. The access node 121 may indicate the supported/selected technique(s) for a given cell or for a given UE 10. The UE may further indicate the supported technique(s), including the maximum number of SPS configuration within a cycle and also the maximum number of monitored SPS within a cycle.

The features and examples described herein may be combined in any manner that is not clearly contradictory, or as any combination of the items set forth below.

Item 1. Method carried out in an access node of a wireless network for scheduling communication with a user equipment, UE, the method comprising:

transmitting (720), to the UE, configuration of scheduled periodic communication occasions for communication with the access node;

transmitting (730), to the UE, information identifying timing adjustment of the communication occasions in relation to a predetermined periodicity associated with the configuration; and

communicating (750) data with the UE using the scheduled periodic communication occasions adjusted based on the timing adjustment.

Item 2. The method of any preceding item 1, wherein communicating data comprises transmitting data to the UE.

Item 3. The method of item 1, wherein communicating data comprises receiving data from the UE.

Item 4. Method carried out in a user equipment, UE, for implementing scheduling of communication with an access node of a wireless network, the method comprising:

receiving (820), from the wireless network, configuration of scheduled periodic communication occasions for communication with the access node;

obtaining (830) information identifying timing adjustment of the communication occasions in relation to a predetermined periodicity associated with the configuration; and

communicating (850) data with the access node using the scheduled periodic communication occasions adjusted based on the timing adjustment.

Item 5. The method of item 4, wherein communicating data comprises receiving data from the access node.

Item 6. The method of item 4, wherein communicating data comprises transmitting data to the access node.

Item 7. The method of any preceding item, wherein said information identifies a reference point in time for application of the timing adjustment to the communication occasions.

Item 8. The method of any preceding item, wherein the configuration identifies semi-persistent scheduling according to said predetermined periodicity.

Item 9. The method of any of preceding item, wherein said configuration identifies said predetermined periodicity, and wherein said information comprises at least one adjustment parameter to be applied to the communication occasions.

Item 10. The method of item 9, wherein said at least one adjustment parameter comprises a time shift, and an adjustment interval identifying a number of communication occasions between adjustment using the time shift.

Item 11. The method of item 9, wherein the predetermined periodicity comprises a first periodicity and a second periodicity, and wherein said adjustment parameter identifies timing for switching between the first periodicity and the second periodicity.

Item 12. The method of item 11, wherein said timing for switching comprises a timing scheme, identifying a number of communication occasions for using one of the first and second periodicities before switching.

Item 13. The method of item 9, wherein said at least one adjustment parameter comprises a timing adjustment to be applied to successive communication occasions of the predetermined periodicity for determining an adjusted periodicity between the communication occasions.

Item 14. The method of any of items 1-8, wherein said predetermined periodicity identifies a non-integer time of arrival, in a unit of time, based on an associated traffic rate, wherein the timing adjustment determines communication occasion timing at an integer number of time by rounding off the non-integer time of arrival based on a rounding function.

Item 15. The method of any of items 1-8, wherein said configuration comprises a plurality of configurations, and wherein said information identifies alternate scheduling of communication occasions among said plurality of configurations.

Item 16. The method of item 15, wherein each of said plurality of configurations use said predetermined periodicity, with a time offset between the communication occasions for said plurality of configurations.

Item 17. The method of item 16, wherein said information configures the UE to monitor the communication occasions for at least two of said configurations in each period of the predetermined periodicity.

Item 18. The method of item 4 in combination with any of items 5-17, wherein said information is obtained from an application layer in association with data communication of application data.

Item 19. The method of any preceding item, wherein said information is provided by radio resource control signaling.

Item 20. The method of any of items 1-18, wherein said information is provided as downlink control information by physical layer signaling.

Item 21. The method of item 4 in combination with any of items 15-17, comprising:

transmitting, to the wireless network, an indication of supported maximum number of configurations for communication of data or for monitoring for communication of data.

Item 22. An access node (121) of a wireless network (100), comprising:

a transceiver (313) for wireless communication with a user equipment; and

logic circuitry (310) configured to control the access node to carry out the method of item 1 for scheduling communication with the UE.

Item 23. A user equipment, UE (10), comprising:

a transceiver (213) for wireless communication with a wireless network; and

logic circuitry (210) configured to control the UE to carry out the method of item 4 for implementing scheduling of communication with an access node of the wireless network.

1. Method carried out in an access node of a wireless network for scheduling communication with a user equipment (UE) the method comprising:
transmitting, to the UE, configuration of scheduled periodic communication occasions for communication with the access node;
transmitting, to the UE, information identifying timing adjustment of the communication occasions in relation to a predetermined periodicity associated with the configuration; and
communicating data with the UE using the scheduled periodic communication occasions adjusted based on the timing adjustment.

2. The method of any preceding claim 1, wherein communicating data comprises transmitting data to the UE.

3. The method of claim 1, wherein communicating data comprises receiving data from the UE.

4. Method carried out in a user equipment (UE) for implementing scheduling of communication with an access node of a wireless network, the method comprising:
receiving, from the wireless network, configuration of scheduled periodic communication occasions for communication with the access node;
obtaining information identifying timing adjustment of the communication occasions in relation to a predetermined periodicity associated with the configuration; and
communicating data with the access node using the scheduled periodic communication occasions adjusted based on the timing adjustment.

5. The method of claim 4, wherein communicating data comprises receiving data from the access node.

6. The method of claim 4, wherein communicating data comprises transmitting data to the access node.

7. The method of claim 4, wherein said information identifies a reference point in time for application of the timing adjustment to the communication occasions.

8. The method of claim 4, wherein the configuration identifies semipersistent scheduling according to said predetermined periodicity.

9. The method of claim 4, wherein said configuration identifies said predetermined periodicity, and wherein said information comprises at least one adjustment parameter to be applied to the communication occasions.

10. The method of claim 9, wherein said at least one adjustment parameter comprises a time shift, and an adjustment interval identifying a number of communication occasions between adjustment using the time shift.

11. The method of claim 9, wherein the predetermined periodicity comprises a first periodicity and a second periodicity, and wherein said adjustment parameter identifies timing for switching between the first periodicity and the second periodicity.

12. The method of claim 11, wherein said timing for switching comprises a timing scheme, identifying a number of communication occasions for using one of the first and second periodicities before switching.

13. The method of claim 9, wherein said at least one adjustment parameter comprises a timing adjustment to be applied to successive communication occasions of the predetermined periodicity for determining an adjusted periodicity between the communication occasions.

14. The method of claim 1, wherein said predetermined periodicity identifies a non-integer time of arrival, in a unit of time, based on an associated traffic rate, wherein the timing adjustment determines communication occasion timing at an integer number of time by rounding off the non-integer time of arrival based on a rounding function.

15. The method of claim 1, wherein said configuration comprises a plurality of configurations, and wherein said information identifies alternate scheduling of communication occasions among said plurality of configurations.

16. The method of claim 15, wherein each of said plurality of configurations use said predetermined periodicity, with a time offset between the communication occasions for said plurality of configurations.

17. The method of claim 16, wherein said information configures the UE to monitor the communication occasions for at least two of said configurations in each period of the predetermined periodicity.

18. The method of claim 4, wherein said information is obtained from an application layer in association with data communication of application data.

19. The method of claim 4, wherein said information is provided by radio resource control signaling.

20. The method of claim 1, wherein said information is provided as downlink control information by physical layer signaling.

21-23. (canceled)
